(19) United States
(12) Patent Application Publication
(10) Pub. No.: US 2026/0163024 A1
(43) Pub. Date: Jun. 11, 2026

(54) FUEL CELL FOR A FUEL CELL STACK

(71) Applicant: MTU Aero Engines AG, München (DE)

(72) Inventors: Ann-Kathrin Henss, Munich (DE); Barnaby Law, Starnberg (DE)

(73) Assignee: MTU Aero Engines AG, München (DE)

(21) Appl. No.: 18/707,019

(22) PCT Filed: Nov. 3, 2022
(86) PCT No.: PCT/DE2022/100808

§ 371 Date: May 2, 2024

(30) Foreign Application Priority Data
Nov. 11, 2021 (DE) 10 2021 129 384.7

(51) Int. Cl. H01M 8/0267; B64D 27/355; B64D 33/08; H01M 8/0258; H01M 8/1004; H01M 8/241

(52) U.S. Cl. CPC H01M 8/0267; B64D 27/355; B64D 33/08; H01M 8/0258; H01M 8/1004; H01M 8/241; H01M 2220/20

(57) ABSTRACT

The invention relates to a fuel cell for a fuel cell stack, which has a first bipolar plate and a catalyst membrane layer, the catalyst membrane layer being subdivided into at least two segments but the first bipolar plate being formed continuously and extending beyond the at least two segments; thus, the at least two segments being electrically connected in parallel, and a first channel structure, which is intended to supply the catalyst membrane layer with a reaction gas being subdivided into at least two segments congruently with the at least two segments of the catalyst membrane layer.

### BACKGROUND OF THE INVENTION

The present invention relates to a fuel cell for a fuel cell stack.

In a fuel cell stack, also known as a stack, several fuel cells are placed next to each other in a stacking direction and in this way are connected in series. As a result, each particular fuel cell can have a bipolar plate and a catalyst membrane layer, in particular, a Catalyst Coated Membrane (CCM). This separates, for example, water and oxygen and simultaneously transports protons from the anode to the cathode. With high-performance applications in mind, such as aviation or the commercial vehicle sector, increasing the Active Cell Area (ACA) of the individual fuel cell can also be of interest. This makes it possible, for example, to set the maximum possible current and consequently, the maximum or nominal power.

### SUMMARY OF THE INVENTION

The present invention forms the basis for the technical problem of designing an advantageous fuel cell.

This is achieved, according to the fuel cell of the present invention in which the catalyst membrane layer is divided into at least two segments, to which, however, a continuous bipolar plate is attached. Consequently, the segments of the catalyst membrane layer are connected in parallel and a desired output power of the cell can be correspondingly adjusted by operating the individual segments, for example, all segments can be operated together (“full load”) or a few of them can be switched off (“partial load”). Owing to the parallel connection, the desired output power is then applied to the bipolar plate, to some extent, integrally across the individual segments.

Control of the individual segments is thereby achieved through their reaction gas supply, that is, a (first) channel structure of the fuel cell is therefore segmented in such a way that it is congruent to the segmentation of the catalyst membrane layer. The latter means, that in the stacking direction, the segments of the channel structure are aligned with those of the catalyst membrane layer. During operation, a reaction gas flows through the channel structure or its segments, for example, water or oxygen, wherein the segmentation allows individual supply and thereby “control” of individual segments of the catalyst membrane layer. For this purpose, the channel structure offers, for example, a separate inlet for the reaction gas for each segment, preferably a separate inlet and outlet. As discussed in detail below, the (first) channel structure is preferably formed by the (first) bipolar plate.

Preferred embodiments are described in the dependent claims and the entire disclosure, however, a detailed distinction is not always made between device and method or use aspects when describing the features; in any case, the disclosure must be read implicitly with regard to all claim categories. If, for example, a fuel cell for a specific operation is described, then this should also be understood as a disclosure of a corresponding operating method, and conversely, with the description of a particular operation mode, a fuel cell suitable for this purpose is also disclosed.

The segments can be operated with different power or can even be completely switched off segment-wise. This setting option can be advantageous, for example, in the sense that operation in a certain load range can be particularly efficient or damage to the fuel cell may occur in fact at particularly low power (e.g. <5-10% of the nominal power). As a result of segmentation, one or more of the segments can then be switched off completely segment-wise, whereas the remaining segment or segments can continue to be operated with a power output above the critical range.

With regard to the fuel cell or the stack as a whole, despite the design for a high nominal power output, it is possible, for example, to reach the low power-output sections, which was otherwise not possible. For example, this could be an interesting application in an aircraft, if, for example, the aircraft is on the runway but waiting for clearance. In the example when the critical range is below 5-10%, only 1.5% to 3% of the nominal power output can be accessed from a fuel cell divided into three segments. Independent of the accessibility to small power outputs, the segmentation and therefore the individual adjustability, for example, also takes into account conditions that vary across the fuel cell, for example, a temperature gradient (depending on its temperature, an optimal operating condition can be set for a corresponding segment).

In general, the bipolar plate is made of an electrically-conductive material, for example, graphitic or preferably metal material. In a preferred embodiment, if the first bipolar plate forms the first channel structure, also known as the flow field, it is therefore structured correspondingly on the side facing the catalyst membrane layer. Specifically, the bipolar plate can be affixed to a plurality of cell connectors, each ascending in the stacking direction, and for example, running parallel to one another, at least section-wise; perpendicular to the stacking direction, the cell connectors delimit the channels of the channel structure. In general, the “stacking direction” is perpendicular to the surface of the fuel cell, in the stacking direction the catalyst membrane layer and the bipolar plate are arranged sequentially (and additional layers; see below); in the fuel cell stack, the individual fuel cells are then positioned one after the other in the stacking direction. The surface directions lie perpendicular to the stacking direction.

In a preferred embodiment, the fuel cell has a seal which seals the segments of the channel structure or catalyst membrane layer against one another. Preferably, the seal has a plurality of sealing elements, which can be designed as multiple parts arranged together or as one integral part, that is, they are connected, wherein a particular segment of the catalyst membrane layer/channel structure is fully enclosed all around by the respective sealing element. A particularly good separation of the segments can be achieved with the seal or the sealing elements.

In a preferred embodiment, a (first) gas diffusion layer, which is stacked between the (first) bipolar plate and the catalyst membrane layer, is also divided into at least two segments. Preferably, the segmentation of the gas diffusion layer is congruent with that of the catalyst membrane layer and channel structure. On the one hand, the gas diffusion layer can distribute the reaction gas to the electrode of the catalyst membrane layer and, on the other hand, conduct the flow from there (and, for example, of water and heat also).

Preferably, a gas diffusion layer is provided on both sides of the catalyst membrane layer. Preferably, a second bipolar plate is arranged on a side opposite the first bipolar plate of the catalyst membrane layer (opposite to the stacking direction). Preferably, the first gas diffusion layer is present between the catalyst membrane layer and the first bipolar plate, and on the opposite side, there is a second gas diffusion layer (between the catalyst membrane layer and the bipolar plate), wherein both gas diffusion layers of the catalyst membrane layer are correspondingly segmented.

According to a preferred embodiment, the second bipolar plate forms the second channel structure on its side facing the catalyst membrane layer through which a reaction gas flows during operation (e.g. oxygen or hydrogen, complementary to the first channel structure). The second channel structure is also preferably segmented, in particular, preferably congruent with the catalyst membrane layer and first channel structure/bipolar plate.

Even independently of these details, it may be of interest to design the first and second channel structures in such a way that their channels are parallel to each other. In this way, the inlet and outlet of the channel structures can be on the same side of the fuel cell or perpendicular to the stacking direction on the opposite side of the fuel cell, and the two other sides can be used, for example, for the supply and discharge of the coolant. Preferably, the channels parallel to each other run in a first surface direction and segmentation is present in relation to a second, perpendicular surface direction.

In a preferred embodiment, the fuel cell typically has a cooling channel through which a coolant flows during operation. In contrast to the first and second channel structure, the cooling channel is not segmented in the preferred embodiment, but rather extends over the at least two segments, preferably over all segments of the catalyst membrane layer. If coolant flows through the channel during operation, it passes through the individual segments one after the other. With the segmentation, this can, for example, result in an advantageous interaction whereby, in partial load operation, an operational segment present upstream can be used to preheat a temporarily non-operational segment downstream, which enables a more efficient switching-on subsequently.

In a preferred embodiment, the segments of the catalyst membrane layer at least partially differ in their material composition. The latter means that not all segments necessarily have to be different; for example, there can also be several segments with the same material composition. Alternatively or in addition to the varying material composition of the catalyst membrane layer, the first and/or second gas diffusion layer can also be at least partially accommodated in the different segments having different material compositions.

The material composition, which varies across the segments, can, for example, take into account a temperature gradient, which can be set, even when all segments are operational, by the sequential flow of the coolant. By appropriately adjusting the material composition, the respective segment or its operational point can be optimized to a respective temperature regime.

In all, the catalyst membrane layer is preferably divided into at least three segments; other possible lower limits can be, for example, at least five, seven, nine or ten segments. An upper limit can also depend on the size, that is area of the fuel cell; for example, 50, 40, 30 or 20 segments.

The invention also relates to a fuel cell stack in which several segmented fuel cells are placed next to each other. Preferably, the segmentation across the fuel cells is congruent, so that common connections can be provided for the reaction gas and preferably also for cooling the individual cells.

The invention also relates to a method for operating a fuel cell or fuel cell stack disclosed here, wherein, in the first operating state, only one or more than one segments are operated, but all segments are not operated. In this way, in particular, smaller total power outputs are accessible, but switching-off individual segments can also take into account any damage that has occurred in one of the segments. The entire fuel cell need not be switched off (immediately), but only the faulty segment can be switched off and the cell or stack can continue to be operated with reduced power.

A method is also advantageous. in which switching on and switching off of segments varies, that is, different segments are turned off in a first operating state than in a second operating state. On an average, this intermittent operation can allow a substantially equal utilization of the individual segments and also regeneration of the individual segments to some extent.

In a second operating state, all segments are operated. Based on the example given initially, the first operating state is present, for example, in the case of the aircraft waiting in the takeoff area, whereas the second state can then be set at take-off and possibly also beyond that.

As mentioned above, in the first operating state, it is preferable if the segments located downstream of the coolant are not operated, but segments located upstream are operated. The segments located away from the flow can be preheated and prepared for subsequent switching on.

The invention also relates to the use of a fuel cell or the stack described here in a drive unit of an aircraft or commercial vehicle.

### BRIEF DESCRIPTION OF THE DRAWING FIGURES

The invention is explained in more detail in the following description, using an exemplary embodiment, whereby certain features in other combinations, in the context of the dependent claims, can also be essential to the invention and, in addition, no distinction needs to be made between the different claim categories.

Taken individually:

FIG. 1 shows a fuel cell in a schematic section;

FIG. 2 shows a top view onto the fuel cell according to FIG. 1;

FIG. 3 shows a stack with multiple fuel cells placed next to each other.

### DESCRIPTION OF THE INVENTION

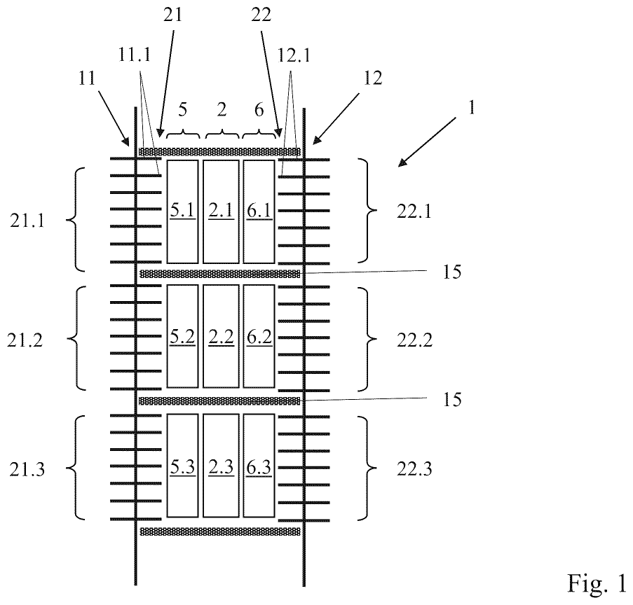

FIG. 1 shows a fuel cell 1, which has a first bipolar plate 11 and a second bipolar plate 12. A catalyst membrane layer is present between the bipolar plates 11, 12, that is, a catalyst coated membrane. This is designed in segments, that is, in the present example, it is divided into a first segment 2.1, a second segment 2.2. and a third segment 2.3. A first gas diffusion layer 5 is arranged between the first bipolar plate 11 and the catalyst membrane layer 2, which is also segmented congruently with the catalyst membrane layer 2; in the present case, it is divided into a first, second and third segment 5.1, 5.2, 5.3. A second gas diffusion layer 6 arranged between the catalyst membrane layer 2 and the second bipolar plate 12 is also subdivided congruently into a first, second, and third segment 6.1, 6.2, 6.3.

The bipolar plates 11, 12 each have several connections 11.1, 12.1 on their side facing the corresponding gas diffusion layer 5, 6; these form a first channel structure 21 and a second channel structure 22. During operation, the corresponding reaction gas flows through these channel structures 21, 22, and diffuses over a large area into the catalyst membrane layer 2 through the respective gas diffusion layer 5, 6. The channel structures 21, 22 are correspondingly segmented; in the present case, they are each divided into a first, second and third segment 21.1, 22.1; 21.2, 22.2; 21.3, 22.3. This enables the segments 2.1-2.3 of the catalyst membrane layer to be individually supplied with reaction gas, that is, their power output can be adjusted independent of one another. In this way, smaller power outputs are, in particular, accessible; see the detailed introduction to the description. For fluidic decoupling, a seal 15 is provided, which seals the segments 2.1 to 2.3 from each other.

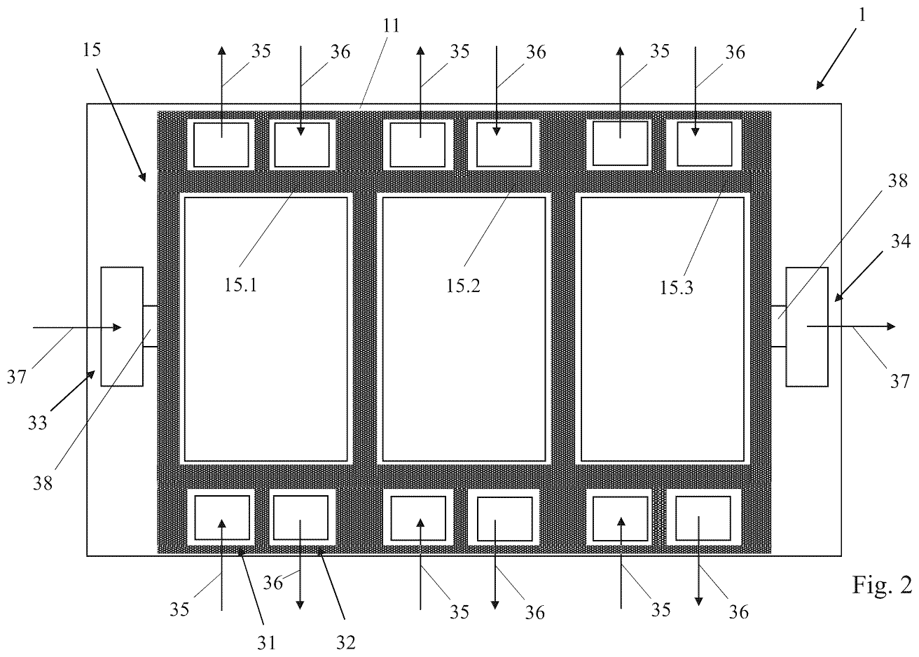

FIG. 2 shows the fuel cell 1 or a part thereof in top view. The segments 2.1-2.3 of the catalyst membrane layer 2 are, as mentioned, sealed from each other by the seal 15, wherein a corresponding sealing element 15.1, 15.2, 15.3 completely surrounds the respective segment 2.1, 2.2, 2.3. Furthermore, the first bipolar plate 11 can be seen in the top view, in which inlets and outlets 31, 32 for the reaction gases 35, 36, as well as inlets and outlets 33, 34 for a coolant 37 are provided at the edge. As shown, counterflow or even a coflow operation is possible.

In the present case, the reaction gases 35, 36 are hydrogen and oxygen or air, whereby each segment 2.1-2.3 is supplied with its own reaction gas, so that the corresponding channel structure 21, 22 (not represented in FIG. 2; compare the overview with FIG. 1 for illustration) can each be supplied individually with the reaction gas 35, 36.

Supply with the coolant 37 via a cooling channel 38, however, affects all segments 2.1-2.3; therefore, the coolant passes through these channels one after the other. This means, for example, if only segment 2.1 is operated, the heat dissipated with the cooling fluid 37 can be used to preheat the downstream segments 2.2, 2.3; see the detailed introduction to the description.

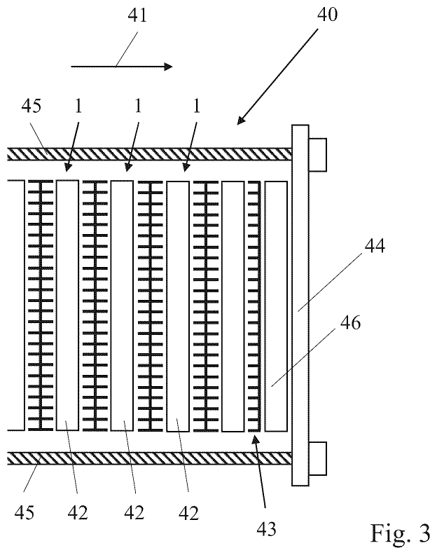

FIG. 3 shows a part of a fuel cell stack 40 with multiple fuel cells 1. These are placed together in a stacking direction 41, wherein the multilayer structure 42 consisting of the respective catalyst membrane layer 2 and gas diffusion layers 5, 6 is summarized here and even the segmentation is not shown. At the end, there is a monopolar plate 43 and a cover plate 44. Tie rods 45 penetrate the latter and are braced against a cover plate at the opposite end (not shown), so that the individual fuel cells 1 are held together under pressure. A current collector plate 46 is also arranged between the cover plate 44 and the monopolar plate 43.

1. A fuel cell for a fuel cell stack, comprising:
a first bipolar plate and
a catalyst membrane layer,
wherein the catalyst membrane layer is subdivided into at least two segments, the first bipolar plate is continuous, and extends over the at least two segments, the at least two segments being connected electrically in parallel, and
whereby a first channel structure, which is provided for supplying a reaction gas to the catalyst membrane layer, is subdivided into at least two segments congruently with the at least two segments of the catalyst membrane layer.

2. The fuel cell according to claim 1, wherein the first bipolar plate forms the first channel structure for a reaction gas on its side facing the catalyst membrane layer.

3. The fuel cell according to claim 1, further comprising a seal, which seals the at least two segments of the first channel structure against each other.

4. The fuel cell according to claim 3, wherein a respective sealing element of the seal surrounds a respective segment of the catalyst membrane layer.

5. The fuel cell according to one claim 1, wherein a first gas diffusion layer is arranged between the first bipolar plate and the catalyst membrane layer, wherein the first gas diffusion layer is subdivided into at least two segments congruently with the at least two segments of the catalyst membrane layer.

6. The fuel cell according to, claim 1, further comprising a second bipolar plate, which is arranged on the side of the catalyst membrane layer facing the first bipolar plate and which forms a second channel structure for a reaction gas on its side facing the catalyst membrane layer, wherein the second channel structure is subdivided into at least two segments congruently with the at least two segments of the catalyst membrane layer.

7. The fuel cell according to claim 6, wherein the first channel structure has first channels and the second channel structure has second channels, wherein the first and second channel structures run parallel to each other.

8. The fuel cell according to has claim 1, further comprising a cooling channel through which a coolant flows, wherein the cooling channel passes through the at least two segments of the catalyst membrane.

9. The fuel cell according to claim 1, wherein the at least two segments of the catalyst membrane layer differ in their material composition.

10. The fuel cell according to claim 1, wherein the catalyst membrane layer is subdivided into at least three segments.

11. A fuel cell stack having a plurality of fuel cells according to claim 1, wherein the plurality of fuel cells are successively arranged in a stacking direction.

12. A method of operating a fuel cell according to claim 1, wherein, in a first operating state, a part of the at least two segments of the catalyst membrane layer is operated, but a different part is not.

13. The method according to claim 12, wherein, in a second operating state, all segments of the catalyst membrane layer are operated.

14. The method according to claim 12 wherein a coolant fluid flows through the cooling channel, wherein the segments of the catalyst membrane layer, which are operated in the first operating state, based on the upstream flow through the cooling channel and the segments, which are not operated in the first operating state, are present downstream of the cooling channel.

15. Use of a fuel cell according to claim 1 in a propulsion system of an aircraft or a commercial vehicle.

16. A method of operating a fuel cell according to claim 11, wherein, in a first operating state, a part of the at least two segments of the catalyst membrane layer is operated, but a different part is not.

17. The method according to claim 16, wherein, in a second operating state, all segments of the catalyst membrane layer are operated.

18. The method according to claim 16 wherein a coolant fluid flows through the cooling channel, wherein the segments of the catalyst membrane layer, which are operated in the first operating state, based on the upstream flow through the cooling channel and the segments, which are not operated in the first operating state, are present downstream of the cooling channel.

19. Use of a fuel cell according to claim 11 in a propulsion system of an aircraft or a commercial vehicle.
